(19) United States
(12) Patent Application Publication
(10) Pub. No.: US 2007/0130163 A1
(43) Pub. Date: Jun. 7, 2007

(54) WORK ITEM MANAGEMENT THROUGH A CLIENT APPLICATION

(75) Inventors: Juan Jose Perez, Seattle, WA (US); Joseph Jensen Buys, Kirkland, WA (US); Brian Edward Trautman, Redmond, WA (US)

Correspondence Address: DARBY & DARBY P.C., P. O. BOX 5257, NEW YORK, NY, 10150-5257, US

(73) Assignee: Personify Design Inc., Seattle, WA (US)

(21) Appl. No.: 11/556,981

(22) Filed: Nov. 6, 2006

Related U.S. Application Data
(60) Provisional application No. 60/733,393, filed on Nov. 4, 2005.

(51) Int. Cl. G06F 17/30

(52) U.S. Cl. 707/10

(57) ABSTRACT

Manipulating work item data with a client application, such as a messaging application, that does not have native capability to manipulate work item data. A user interface is provided through the client application that enables a user to create, edit, delete, search, or otherwise manipulate a state of the work item data that is native to a work management application, such as a software development environment. In one embodiment, a work item toolbar is provided in the client application to enable a user to manipulate the work item data. Data fields of the work management application are mapped to data fields of the client application. In one embodiment, work item data is created or exchanged between a messaging client application and an independent software development environment through a shared data store. The work item data may be populated with default settings.

### CROSS-REFERENCE TO RELATED APPLICATIONS

This application claims the benefit of United States Provisional Patent Application 60/733,393 filed Nov. 4, 2005; the contents of which are hereby incorporated by reference.

### FIELD OF ART

The present invention relates generally to work item management, and more particularly, but not exclusively, to creating and managing work items through a user interface of a client application, such as a message communication system, that is arranged to execute independent of a work management application.

### BACKGROUND

Work items generally include information about a requirement, task, action, event, or other trackable unit. Work items may be assigned and tracked to manage a project, such as a software development project. Electronic work item management is included in some software development environments, such as Microsoft Corporation's Visual Studio™. Users of such development environments may view and manage work items for a variety of projects. People who do not have access to, or are not trained to use, the development environment may not easily obtain information about work items managed through the development environment. For example, managers of a software development project may have to rely on printed reports or assistance from others to obtain, create, or change work item information. This may reduce efficiency.

Also, communication regarding a development project often occurs outside the software development environment. For example, developers and/or managers may exchange emails, instant messages, hand written notes, verbal communications, or the like. Such communications may lead to creation of, or revision to, work items. Generally, information from such communications is manually transferred to work items within the development environment. This may also reduce efficiency. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a client and/or server device that may be included in a system implementing the invention;

FIG. 3 is a block diagram illustrating an architecture that may be used to implement an embodiment of the invention;

FIG. 4 is a block diagram illustrating a hierarchical visualization of an architecture that may be used to implement an embodiment of the invention;

FIG. 5 is a screen shot illustrating an email message window, including a work item tool bar with buttons for creating work items from within the email message window;

FIG. 6 is a screen shot illustrating a sample work item form that is displayed upon the user selecting one of the buttons to create a work item;

FIG. 7 is a screen shot illustrating a summary view of work items and work item folders, which are accessible through an email client;

FIG. 8 is a screen shot illustrating an options dialog box that is displayed upon selection of an “Options” menu operation;

FIG. 9A is a screen shot illustrating the options dialog box with a Project tab displayed;

FIG. 9B is a screen shot illustrating a drop down box of various work item types that may be selected;

FIG. 9C is a screen shot illustrating a drop down box of various data fields that may be mapped to email subject lines;

FIG. 10 is a flow diagram illustrating logical operations for an exemplary embodiment;

FIG. 11 is a flow diagram illustrating exemplary logic operations that are generally performed upon selection of the Options menu item;

FIG. 12 is a flow diagram illustrating example logical operations for adding a project;

FIG. 13 is a flow diagram illustrating example logical operations for setting a default server and project;

FIG. 14 is a flow diagram illustrating example logical operations for selecting a server and project to be associated with newly created work items from email messages;

FIG. 15 is a flow diagram illustrating example logical operations for updating mapping data;

FIG. 16 is a flow diagram illustrating example logical operations for establishing communication with a development environment server to access associated work items;

FIG. 17 is a flow diagram illustrating example logical operations for determining and displaying work items associated with a selected server and project;

FIG. 18 is a flow diagram illustrating example logical operations for displaying data for a selected work item;

FIG. 19 is a flow diagram illustrating example logical operations for determining available work item types; and

FIG. 20 is a flow diagram illustrating example logical operations for creating a work item from an email message.

### DETAILED DESCRIPTION OF THE INVENTION

Embodiments of the present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely software embodiment, an entirely hardware embodiment or an embodiment combining software and hardware aspects. The following detailed description is, therefore, not to be taken in a limiting sense. Briefly stated, the following embodiments of the present invention are directed towards enabling a user to manipulate work item data through a client application, such as a message communication system, that does not have native capability to manipulate work item data. Embodiments are also directed to managing work item data through the user interface of the client application that is arranged to execute independent of a work management application. The work item data and settings related to the work item data are accessible to both the work management application and the client application through their respective interfaces.

The terms “comprising”, “including”, “containing”, “having,” and “characterized by,” refer to an open-ended or inclusive transitional construct and does not exclude additional, unrecited elements, or method steps. For example, a combination that comprises A and B elements, also reads on a combination of A, B, and C elements. The meaning of “a,” “an,” and “the” include plural references. The meaning of “in” includes “in” and “on.” Additionally, a reference to the singular includes a reference to the plural unless otherwise stated or is inconsistent with the disclosure herein. The term “or” is an inclusive “or” operator, and includes the term “and/or,” unless the context clearly dictates otherwise. The phrase “in one embodiment,” as used herein does not necessarily refer to the same embodiment, although it may. Similarly, the phrase “in another embodiment,” as used herein does not necessarily refer to a different embodiment, although it may. The term “based on” is not exclusive and provides for being based on additional factors not described, unless the context clearly dictates otherwise. The term “user” can include a computer user, an online service subscriber, an administrative user and/or other person using an electronic device.

Illustrative Operating Environment

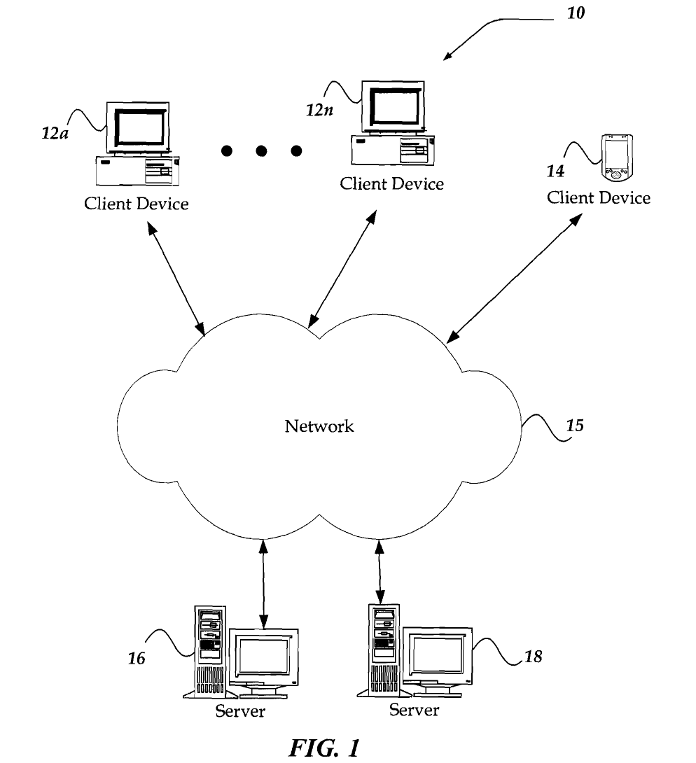

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, a system 10 includes client devices 12-14, a network 15, and one or more servers, such as servers 16 and 18. Network 15 is in communication with and enables communication between each of client devices 12-14, and servers 16 and 18.

Client devices 12-14 may include virtually any computing device, including devices capable of receiving and sending a message over a network, such as network 15, to and from another computing device, such as servers 16 and 18, each other, or the like. The set of such devices may include devices that are usually considered general purpose devices and typically connect using a wired communications medium such as personal computers, multiprocessor systems, microprocessor-based or programmable consumer electronics, network PCs, or the like. The set of such devices may also include mobile terminals that are usually considered more specialized devices and typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, or the like. Similarly, client devices 12-14 may be any device that is capable of connecting using a wired or wireless communication medium such as a personal digital assistant (PDA), POCKET PC, wearable computer, and any other device that is equipped to communicate over a wired and/or wireless communication medium.

Each client device within client devices 12-14 includes a user interface that enables a user to instruct the client device to perform operations, and to control settings, such as display settings, presence settings, or the like. Each client device also includes a communication interface that enables the client device to send and receive messages from another computing device employing the same or different communication mode, including, but not limited to email, instant messaging (IM), short message service (SMS) messaging, multi-media system (MMS) messaging, internet relay chat (IRC), Mardam-Bey's internet relay chat (mIRC), Jabber, or the like. Client devices 12-14 may be further configured with a browser application that is configured to receive and send web pages, web-based messages, or the like. The browser application may be configured to receive and display graphics, text, multimedia, or the like, employing virtually any web based language, including, but not limited to Standard Generalized Markup Language (SGML), HyperText Markup Language (HTML), Extensible Markup Language (XML), a wireless application protocol (WAP), a Handheld Device Markup Language (HDML), such as Wireless Markup Language (WML), WMLScript, JavaScript, or the like.

Network 15 is configured to couple one computing device to another computing device to enable them to communicate. Network 15 is enabled to employ any form of medium for communicating information from one electronic device to another. Also, network 15 may include a wireless interface, such as a cellular network interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize cellular telephone signals over air, analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 15 includes any communication method by which information may travel between client devices 12-14, and/or servers 16 and 18. Network 15 is constructed for use with various communication protocols including transmission control protocol/internet protocol (TCP/IP), WAP, code division multiple access (CDMA), global system for mobile communications (GSM), or the like.

The media used to transmit information in communication links as described above generally includes any media that can be accessed by a computing device. Computer-readable media may include computer storage media, wired and wireless communication media, or any combination thereof. Additionally, computer-readable media typically embodies computer- readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, or the like, in the signal. By way of example, communication media includes wireless media such as acoustic, RF, infrared, and other wireless media, and wired media such as twisted pair, coaxial cable, fiber optics, wave guides, and other wired media.

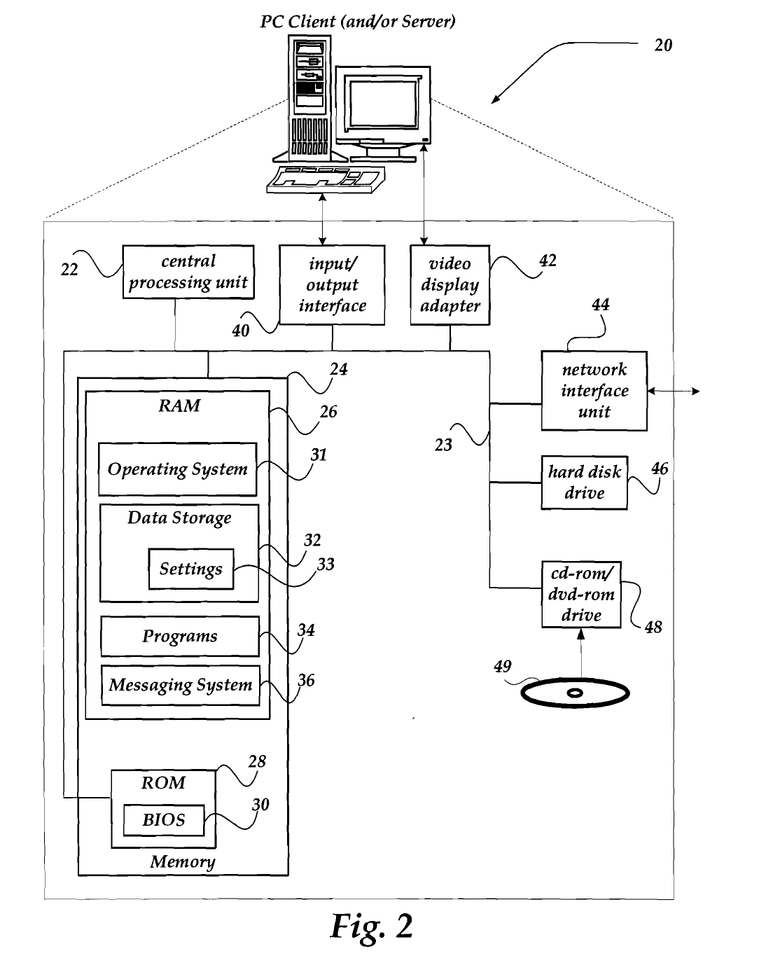

One embodiment of a general purpose client computing device, such as a client device 20, is described in more detail below in conjunction with FIG. 2. Briefly, client device 20 may include any computing device, including those capable of connecting to network 15 to enable a user to communicate with other client devices and/or servers 16 and 18. Client device 20 may include many more components than those shown. The components shown, however, are sufficient to disclose an illustrative embodiment for practicing the invention. Many of the components of client device 20 may also be duplicated in servers 16 and 18, and/or other server devices.

FIG. 2 shows one embodiment of PC Client (and/or server) 20 that may be included in a system implementing the invention. PC Client (and/or server) 20 may include many more or less components than those shown in FIG. 2. However, the components shown are sufficient to disclose an illustrative embodiment for practicing the present invention. PC Client (and/or server) 20 may represent, for example, Client Devices 12-14 and/or Servers 16-18 of FIG. 1. For convenience, and without limitation, the following discussion refers to PC Client (and/or server) 20 as client device 20.

As shown in the figure, client device 20 includes a processing unit 22 in communication with a mass memory 24 via a bus 23. Mass memory 24 generally includes a RAM 26, a ROM 28, and other storage means. Mass memory 24 illustrates a type of computer-readable media, namely computer storage media. Computer storage media may include volatile and nonvolatile, removable and non-removable media implemented in any method or technology for storage of information such as computer readable instructions, data structures, program modules or other data. Other examples of computer storage media include EEPROM, flash memory or other semiconductor memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Mass memory 24 stores a basic input/output system (“BIOS”) 30 for controlling low-level operation of client device 20. The mass memory also stores an operating system 31 for controlling the operation of client device 20. It will be appreciated that this component may include a general purpose operating system such as a version of Windows™, UNIX, LINUX™, or the like. The operating system may also include, or interface with a Java virtual machine module that enables control of hardware components and/or operating system operations via Java application programs.

Mass memory 24 further includes one or more data storage units 32, which can be utilized by client device 20 to store, among other things, program settings 33 and/or other data. The mass memory may also store programs 34 that may include computer executable instructions which can be executed by client device 20 to implement work management applications, software development environments, schedulers, calendars, browsers, web services, transcoders, database programs, word processing programs, spreadsheet programs, and so forth. Programs 34 may also include computer executable instructions which can be executed by client device 20 (and/or servers 16 and/or 18) to implement a communications handler application (such as an HTTP handler application) for transmitting, receiving or otherwise processing communications. Similarly, programs 34 may include a secure communications handler application (such as an HTTPS handler application) for handling secure connections, such as initiating communication with an external application in a secure fashion. Accordingly, programs 34 may process text, audio, video, web pages, or enable telecommunication with another user of another electronic device.

In addition, mass memory 24 stores a messaging system 36, which may include computer executable instructions run under control of operating system 31 to enable email, instant messaging, SMS, and/or other messaging services. Similarly, client device 20 and/or server devices 16 and/or 18 configured much like client device 20, can include a server messaging system, which may further provide routing, access control, and/or other server-side messaging services. As described in more detail below, messaging system 36 may include a plug-in or other module that enables a user to access and/or manage work items associated with a different software system. Alternatively, or in addition, a plug-in or other module may be incorporated into, or interfaced with, other client programs that enable a user to access and/or manage work items associated with the different software system.

Client device 20 also includes an input/output interface 40 for communicating with input/output devices such as a keyboard, mouse, wheel, joy stick, rocker switches, keypad, printer, scanner, and/or other input devices not specifically shown in FIG. 2. A user of client device 20 can use input/output devices to interact with a user interface that may be separate or integrated with operating system 31, programs 34, messaging system 36, and/or other modules. Interaction with the user interface includes visual interaction via a display, and a video display adapter 42.

Client device 20 may include a removable media drive 48 and/or a permanent media drive 46 for computer-readable storage media. Removable media drive 48 can comprise one or more of an optical disc drive, a floppy disk drive, and/or a tape drive. Permanent or removable storage media may include volatile, nonvolatile, removable, and non-removable media implemented in any method or technology for storage of information, such as computer readable instructions, data structures, program modules, or other data. Examples of computer storage media include a CD-ROM 49, digital versatile disks (DVD) or other optical storage, magnetic cassettes, magnetic tape, magnetic disk storage or other magnetic storage devices, RAM, ROM, EEPROM, flash memory or other memory technology, or any other medium which can be used to store the desired information and which can be accessed by a computing device.

Via a network communication interface unit 44, client device 20 can communicate with a wide area network such as the Internet, a local area network, a wired telephone network, a cellular telephone network, or some other communications network, such as network 15 in FIG. 1. Network communication interface unit 44 is sometimes known as a transceiver, transceiving device, network interface card (NIC), or the like.

Illustrative Architecture

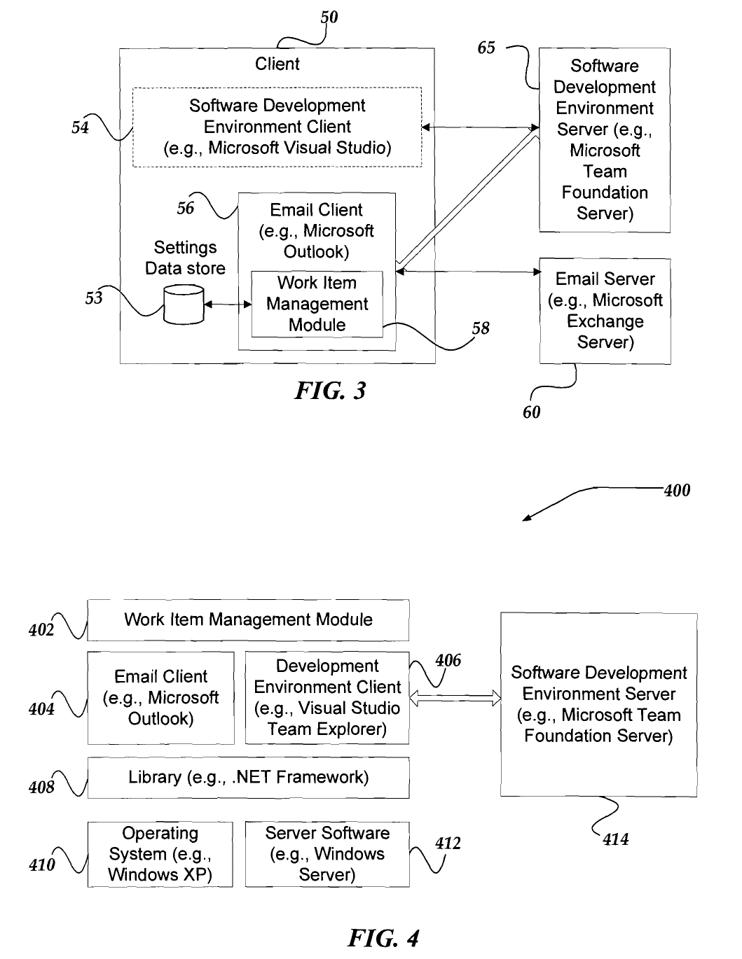

FIG. 3 is a block diagram illustrating an architecture that may be used to implement an embodiment of the invention. All of the following elements may be operated on a single computing device or further distributed over a number of computing devices. The following embodiment is described in terms of integration with an email system. However, the invention is not so limited, and may be incorporated in, interfaced with, or otherwise implemented in relation to other applications that are generally separate from a work item management system. In the following example embodiment, a client 50 may include a client application like an email client 56, such as Microsoft Corporation's Outlook™. The email client may include or interface with a work item management module 58 that controls and/or performs many of the operations discussed in more detail below. The work item management module communicates with a settings data store 53, which stores data mappings, configurations, or other data.

Email client 50 may optionally include a work management client application like a software development environment client 54, such as Microsoft Corporation's Visual Studio™.

Some clients may not include the software development environment, such as clients used by managers. For those clients that include software development environment client 54, they generally communicate with a work item management server application like a software development environment server 65, such as Microsoft Corporation's Team Foundation Server™, which stores and manages software development data and services that may be used by one or more software development clients.

Similarly, email client 56 generally communicates with an email server 60, such as Microsoft Corporation's Exchange Server™, which stores and manages email data and services that may be used by one or more clients. Work item management module 58 enables communication between email client 56 and software development environment server 65, so that work items associated with the software development environment may be accessed and managed via independent email client 56.

FIG. 4 is a block diagram 400 illustrating a hierarchical visualization of an architecture that may be used to implement an embodiment of the invention. All of the elements may be operated on a single computing device or further distributed over a number of computing devices. In this example, an operating system 410, such as Microsoft Corporation's Windows XP™, and server software 412, such as Microsoft Corporation's Windows Server™, provide fundamental computing services. A services library 408, such as Microsoft Corporation's .NET Framework™, provides application programming interfaces (APIs) and/or other low level services that interface with the operating system and/or server software. An email client 404, such as Microsoft Corporation's Outlook™, may use some of the low level services and/or communicate directly with the operating system 410 and/or server software 412.

Similarly, a module of a development environment client 406, such as Microsoft Corporation's Visual Studio Team Explorer™, may use some of the low level services and/or communicate directly with the operating system 410 and/or server software 412. The development environment client 406 also communicates with a software development environment server 414, such as Microsoft Corporation's Team Foundation Server™, to access work item data and/or services. A work item management module 402 interfaces with the email client 404 and the development environment client module 406 to enable a user to manage software development work items via the email client 404.

Illustrative User Interfaces

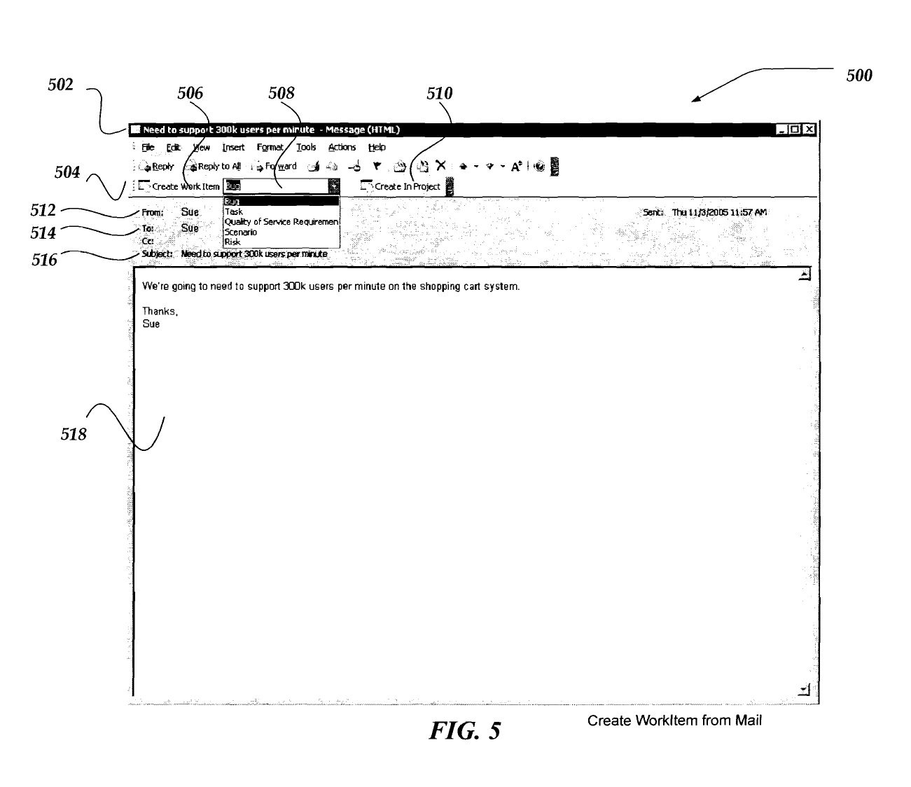

FIG. 5 is a screen shot 500 illustrating an email message window 502. The email message window 502 includes a work item tool bar 504 with buttons for creating work items from within the email message window. A “create work item” button 506 includes a drop down menu 508 from which a user may select various types of work items that may be created. For example, a user may select to create a work item for a bug, a task, a quality of service requirement, a scenario, the risk, and/or other issues that may require tracking through a work item management system. The “create work item” button 506 may be used to create a work item within the default server and project. Alternatively, a “create in project” button 510 may be used to create a work item that is associated with a selected project.

In either case, data associated with the email message may be mapped to data associated with the created work item. For example, the name of the message sender 512 may be mapped to a work item data field identifying the person who assigned the work item, and who requires regularly scheduled status information and/or notification when the work item is completed. Similarly, the name of the message recipient 514 may be mapped to a work item data field identifying the person assigned the work item. Multiple recipients of the message, and/or recipients who were CC'd on the message, may be assigned the work item as a team. In addition, or alternatively, the multiple recipients may be mapped to a data field identifying people who should be notified when the work item is completed. The subject line 516 of the e-mail message may be mapped to a title of the work item. In addition, the body 518 of the email message may be mapped to a description of the work item. The body 518 of the e-mail message may also be parsed for predefined keywords, phrases, and/or other data that may be mapped to fields of the work item. The various field mappings may be predefined or user-defined. Some data may also be mapped into other parts of the email system and/or other applications while a work item is being created or modified. For example, a schedule item may be added to an electronic calendar at a predefined default period from the date the work item is created.

Other buttons (not shown) may provide other services. For example, if the email message is part of a thread and a prior message in the thread was associated with a work item, a review button may be provided to review the associated work item. Similarly, if messages in the thread were associated with multiple work items, the review button may enable a user to review all of the work items associated with the email thread. Future emails in the thread may be automatically associated with one or more work items. A search button (not shown) may be used to search for work items. Other buttons, menu items, icons, animations, or other display elements may enable the user to generate reports, modify associated work items, and/or other operations. Buttons and/or other display elements may also enable access to work item operations through a main view of the email client. For example, a summary view that displays a list of emails may include a work item toolbar of buttons that enables a user to access work items with, or without, relation to a selected email message. A toolbar of buttons and/or other display elements may further enable access to work item operations through a calendar view, through other views of the email client, and/or through other client applications, such as through a word processing application, through a spreadsheet application, through a database application, through a browser application, or the like.

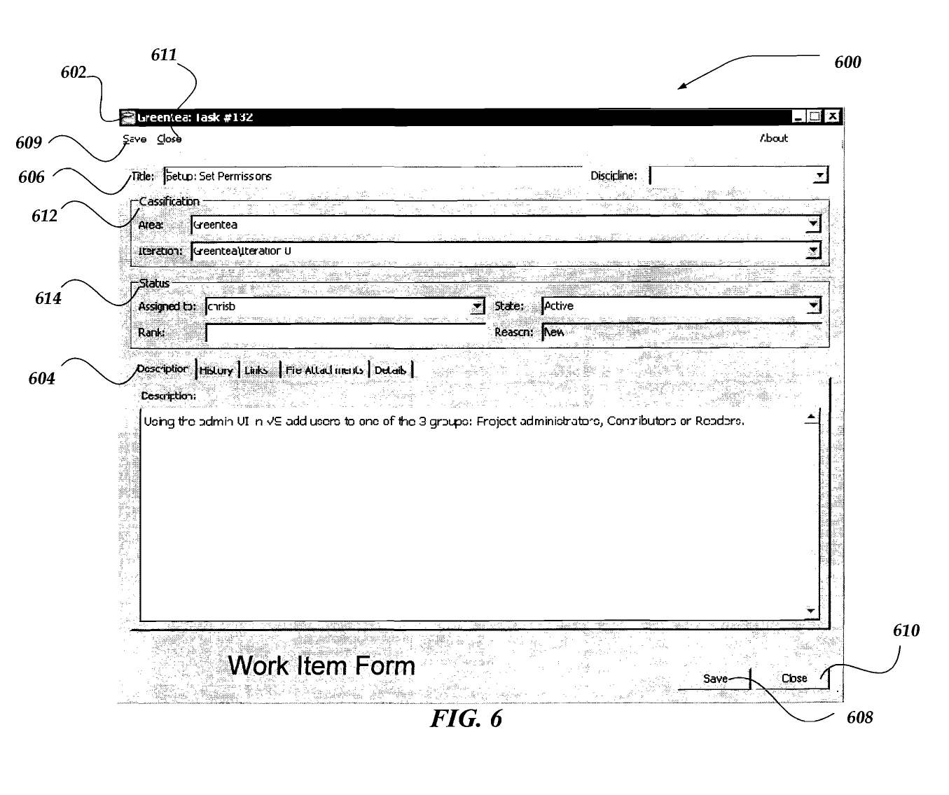

FIG. 6 is a screen shot 600 illustrating a sample work item form 602 that is displayed upon the user selecting one of the buttons to create a work item. Some of the work item data fields may be automatically populated with data from an email message or other source as described above. Some of the data from the email message may not necessarily be displayed in the work item form, since it may be assumed that the user knows some of the information. The data may also be revised in the work item form. For example, classification section 612 may include drop down menus for area and iteration. These fields may be populated with data from the email message or may be populated from another source. Also, status section 614 may include work item data fields for assignee, rank, state and reason. Likewise, these fields may be populated with data from the email message or may be populated from another source.

Some of the data fields, themselves, may be defined by users during a set up operation. The form fields are generally associated with fields of a work item database, which is generally controlled by the software development environment server. However, some nonstandard data fields may be associated with a separate database. Some of the fields may have drop down selection boxes, radio button selection boxes, or other data selection elements.

Similarly, the work item form 602 may include selectable tabs 604 for categorized information. In addition to the description, history, links, attachments, and details tabs, the work item may include higher level tabs that may provide contextual information related to the work item, the type of work item, the project, and/or other aspects. For example, a Guidance tab (not shown) above the title field 606 may provide access to another form or dialog box that provides information about a methodology on how a user should interact with the work item. A User Note tab (not shown) above the title field 606 may provide information generally regarding the work item type, which would also apply to the created work item.

A save button 608 and/or menu item 609 enables the user to store entered and/or revised information in the software development environment server database and/or separate work item database. Alternatively, a close button 610 and/or menu item 611 enables the user to close the work item form without saving.

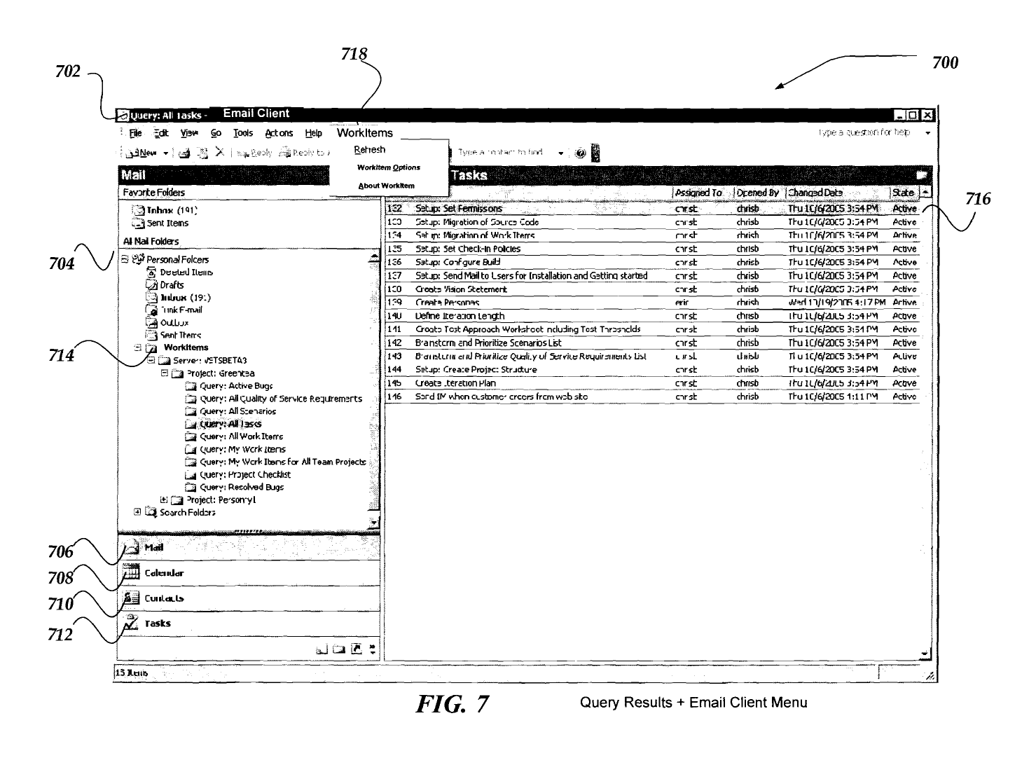

FIG. 7 is a screen shot 700 illustrating a summary view 702 of work items and work item folders, which are accessible through an email client. A left pane 704 enables a user to access folders for a variety of information available through the email client, such as email messages 706, calendar events 708, contact information 710 and/or tasks 712 not associated with a separate service, such as the software development environment. The left pane 704 is sometimes referred to as a folder explorer. The illustrated left pane 704 includes a folder view, in which numerous message folders are displayed, including an inbox folder, a sent items folder, or the like. Also displayed is a work items folder, such as the WorkItems folder 714. Work items subfolders may be organized by servers, projects, and/or other categories. A folder or subfolder may also include one or more predefined query folders that enable access to subsets of work items. For example, an “All Tasks” query folder may be selected to access all work items from the software development environment server that are associated with the Greentea project, which it is stored on a server named VSTBETA3.

A right pane 716 displays a list of items for a selected folder, such as inbox email messages or work items of a selected project folder. The list of work items may be accessed dynamically from a server upon selection of a folder. Alternatively, the list of work items may be accessed at startup of the email client and cached locally. A preview pane (not shown) may also display content of a selected work item.

A user may access operations related to the work items through a work items menu, such as the illustrated WorkItems menu 718. The WorkItems menu 718 includes a refresh operation to obtain current information from the work items database, such as the software development environment server database. An “Options” menu operation enables a user to define settings as described in more detail below. An “About” menu operation provides information about the work items software, which may include help documentation. Other menu items may include a search operation, a create operation, an open operation, a delete operation, and/or other operations.

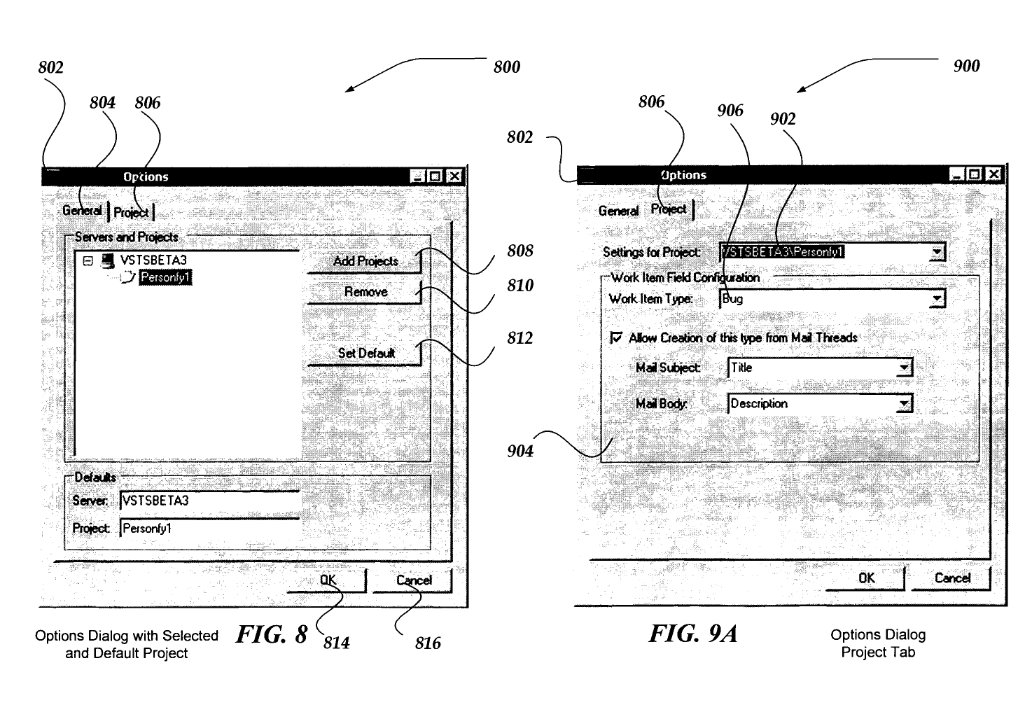

FIG. 8 is a screen shot 800 illustrating an options dialog box 802 that is displayed upon selection of the “Options” menu operation. The options dialog box includes a General tab 804 and/or a project tab 806. FIG. 8 illustrates data and operations available through the General tab. In this case, a user may select a server and/or project folder to access and/or set as defaults. Buttons within the General tab may enable the user to add projects 808, remove projects 810, set defaults 812, and/or perform other operations. An OK button 814 enables the user to close the dialog box and save the settings. Conversely, a Cancel button 816 enables the user to close the dialog box without saving the settings.

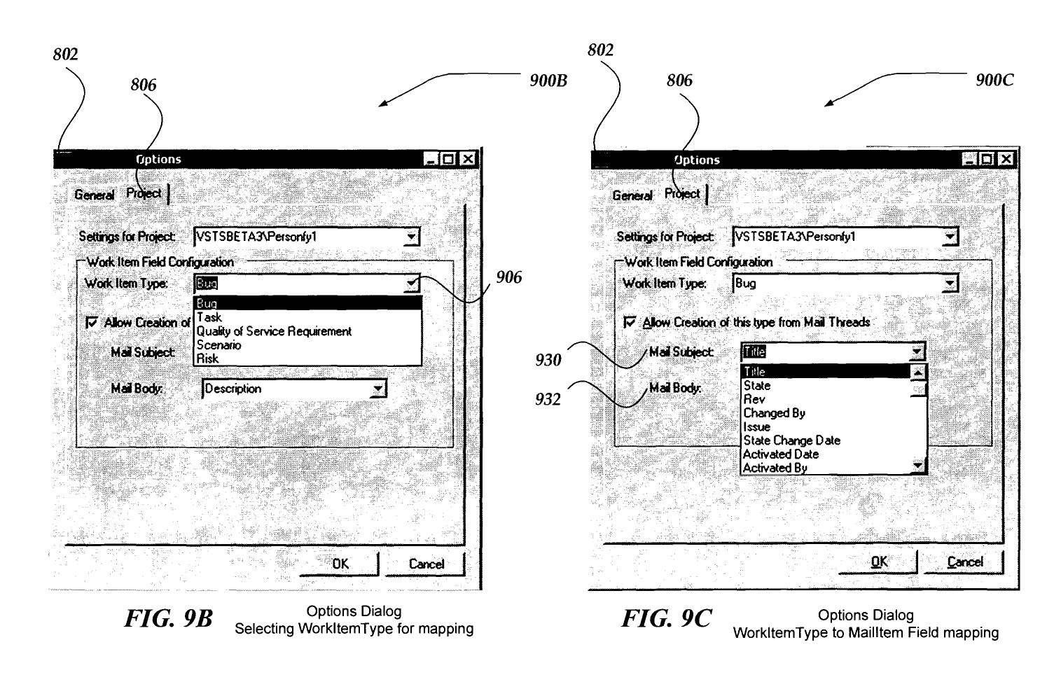

FIG. 9A is a screen shot 900 illustrating the options dialog box 802 with the Project tab 806 displayed. The Project tab may include a number of drop down boxes, checkboxes, and/or other data fields for defining settings associated with a selected project. The Project may be selected through a Project drop down box 902. A configuration section 904 may include the selectable settings. For example, the user may select a work item type 906 as a default for newly created work items associated with the selected project.

FIG. 9B is a screen shot 900B illustrating a drop down box 906 of other work item types that may be selected. The user may also define mappings between email message fields and work item fields. For instance, the user may map email message subject lines to the title field of created work items. FIG. 9C is a screen shot 900C illustrating a drop down box of other data fields that may be mapped to email subject lines 930. Similarly, the user may map email bodies 932 to the description field of created work items.

Illustrative Logic

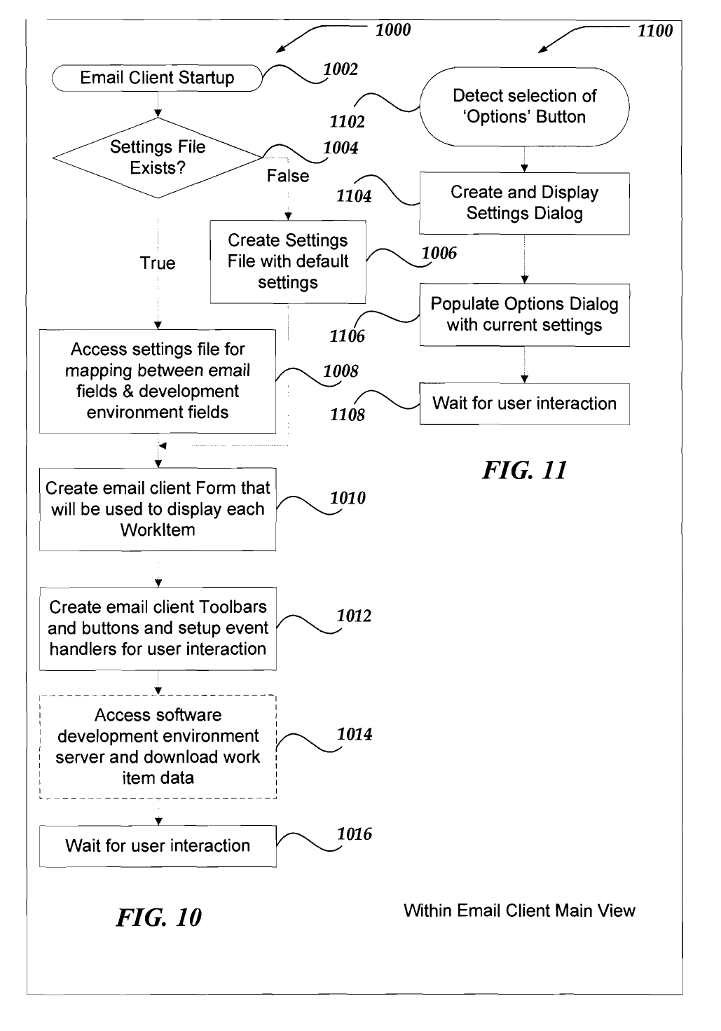

FIGS. 10-20 are flow diagrams illustrating logical operations for an exemplary embodiment. This embodiment is discussed in terms of a single client computing device in communication with a single server computing device to access and manage work item data via an email application. However, the operations may be distributed over multiple client and/or server computing devices, and may be performed via any other type of application.

FIG. 10 is a flow diagram 1000 illustrating example initialization operations that are generally performed by a client. Upon startup of the email client at operation 1002, the work item management module is loaded and checks for an existing settings file at decision operation 1004. If a settings file does not currently exist on the client, the work item management module creates a settings file with default settings at operation 1006. As discussed above, the settings file includes mappings between e-mail fields and work item fields of the software development environment work item database. If a settings file does currently exist, the client accesses the settings file at operation 1008. In either case, the work item management module then creates an email form template at operation 1010. The email form template can be used for displaying work items via the email client. At operation 1012, the work item management module further creates and displays one or more menu options and/or toolbars, such as those described above. Corresponding event handlers are also created and/or initialized. At operation 1014, the work item management module may optionally establish a communication connection with the software development environment server during initialization or wait until a user command requires it. If an initial connection is established, existing work item data may be downloaded and cached for faster access. The work item management module then waits for user interaction with the user interface at operation 1016.

FIG. 11 is a flow diagram 1100 illustrating exemple logic operations that are generally performed upon selection of the Options menu item. Upon detecting selection of the “Options” button at operation 1102, the work item management module creates and displays the options settings dialog box as operation 1104, illustrated in FIGS. 8 and 9A. The work item management module accesses the settings file in the settings data store and populates the dialog box with current or most recent settings at operation 1106. At operation 1108, the work item management module then waits for user interaction with the dialog box.

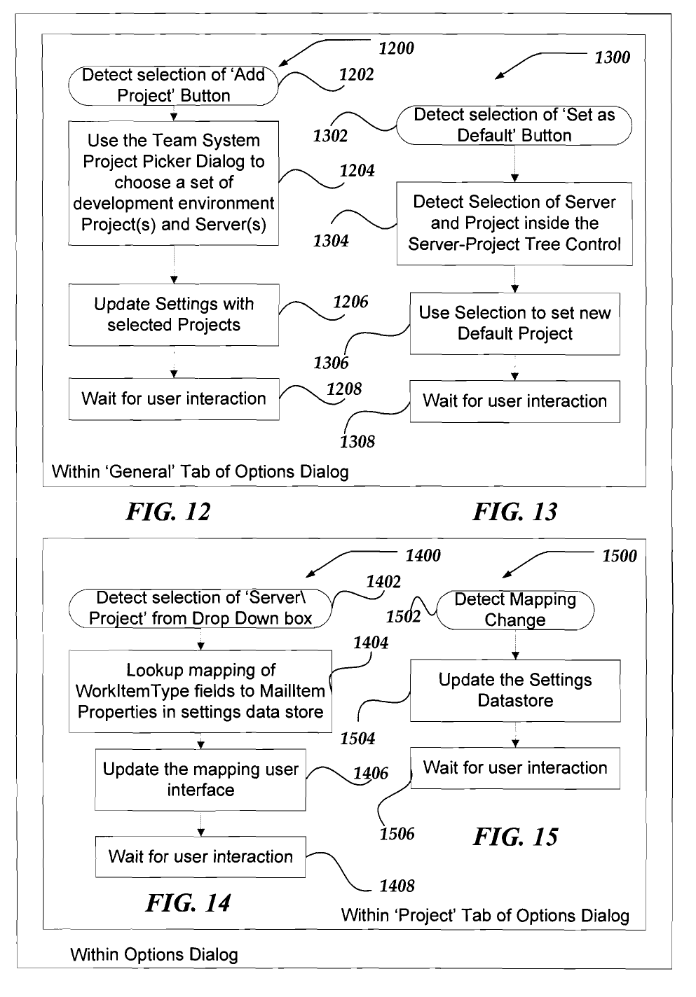

FIGS. 12-15 are flow diagrams illustrating example logical operations for selecting settings through the various dialog elements illustrated in FIGS. 8 through 9C. FIG. 12 is a flow diagram 1200 illustrating example logical operations for adding a project. Upon detecting user selection of the “Add Project” button at operation 1202, the work item management module communicates through the network to determine which software development environment servers and projects are available, at operation 1204. The available servers and projects are displayed in the dialog box. When a user selection is detected at operation 1206, the work item management module updates the settings file with the selected servers and projects. The selected servers and projects can be displayed as folders in the left pane of the email client, as illustrated in FIG. 7. At operation 1208, the work item management module then waits for further user interaction with the dialog box.

FIG. 13 is a flow diagram 1300 illustrating example logical operations for setting a default server and project. At operation 1302, the work item management module detects selection of the “Set Default” button. The work item management module detects selection of a server and project within the dialog box at operation 1304. Accordingly, the work item management module updates the settings file with the selected server and project at operation 1306. Again, at operation 1308, the work item management module waits for further user interaction with the dialog box.

FIG. 14 is a flow diagram 1400 illustrating example logical operations for selecting a server and project to be associated with newly created work items from email messages. The logical operations utilize drop down boxes illustrated in FIG. 9A corresponding to the Project tab in the dialog box. Upon detecting selection of a server and project combination from the drop down box at operation 1402, the work item management module accesses the data store settings file for any existing mapping of email property fields to work item fields at operation 1404. At operation 1406, if a mapping exists, the work item management module populates the corresponding fields in the dialog box. If a mapping does not exist, the corresponding fields may be populated with default mapping data. Again, at operation 1408, the work item management module waits for further user interaction with the dialog box.

FIG. 15 is a flow diagram 1500 illustrating example logical operations for updating mapping data. If the user modifies any of the mapping fields at operation 1502, the work item management module detects the user selections and/or entries, updates the display in the dialog box, updates the settings file at operation 1504, and waits for further user interaction at operation 1506.

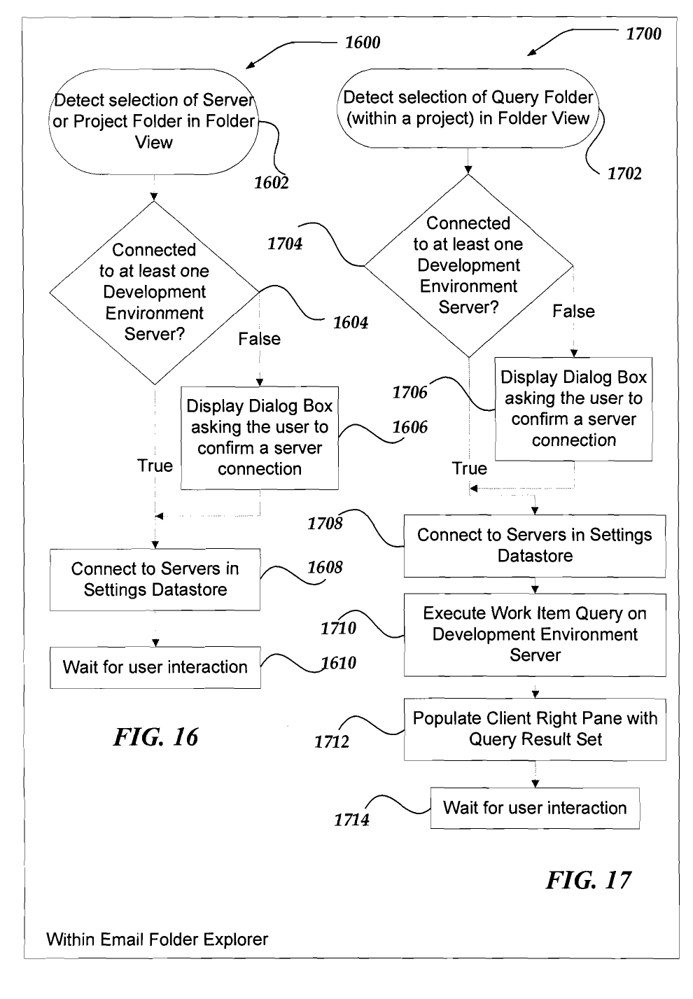

FIGS. 16-20 are flow diagrams illustrating example logical operations for performing operations through the email environment as illustrated in FIGS. 5 through 7. FIG. 16 is a flow diagram 1600 illustrating logical operations for establishing communication with a development environment server to access associated work items. As shown in FIG. 7, servers and projects are displayed in a left pane folder view (e.g., Microsoft Corporation's Outlook™ folder explorer). Upon detecting a user's selection of a server or project folder in the left pane folder view, at operation 1602, the work item management module determines, at decision operation 1604, whether a connection already exists with at least one development environment server (e.g., with Microsoft Corporation′ Team Foundation Server). If not, a dialog box is displayed at operation 1606, requesting the user to confirm a server connection. Once a connection exists, the work item management module checks the settings file for all servers to be accessed and makes corresponding communication connections at operation 1608. The connected servers are displayed in the folder view. Again, at operation 1610, the work item management module waits for further user interaction with the dialog box.

FIG. 17 is a flow diagram 1700 illustrating example logical operations for determining and displaying work items associated with a selected server and project. Within a project folder, a user may select from one or more query folders to determine associated work items. When a query folder is selected at operation 1702, the work item management module determines whether a connection exists with at least one development environment server at decision operation 1704. If a connection does not exist, a dialog box is displayed at operation 1706, requesting the user to confirm a server connection. Once a connection exists, the work item management module may check the settings file at operation 1708 for all accessible servers or check for permissions to access the server associated with the selected query folder. An administrator may specify access privileges in the settings file for various levels of users.

When the needed server connection is made, the work item management module submits a query to the server, which executes the query at operation 1710 and returns resulting work item data. The returned work item data is displayed in the right pane of the client display at operation 1712, as shown in FIG. 7. Again, at operation 1714, the work item management module waits for further user interaction with the dialog box.

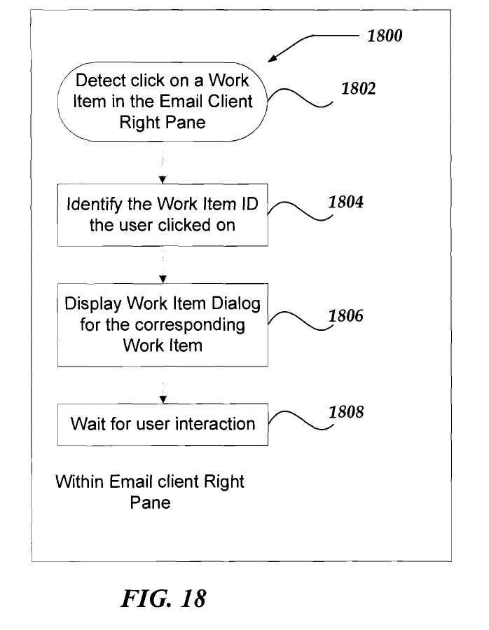

FIG. 18 is a flow diagram 1800 illustrating example logical operations for displaying data for a selected work item. If a work item is selected from a list of work items in the right pane at operation 1802, the work item management module determines a work item identifier for the selected work item at operation 1804. Using the identifier, the work item management module accesses work item data from a local cache or from the corresponding development environment server. Then, at operation 1806, the work item data is displayed in a work item form window, such as that illustrated in FIG. 6. The user may then enter and/or modify work item data. Again, at operation 1808, the work item management module waits for further user interaction with the dialog box.

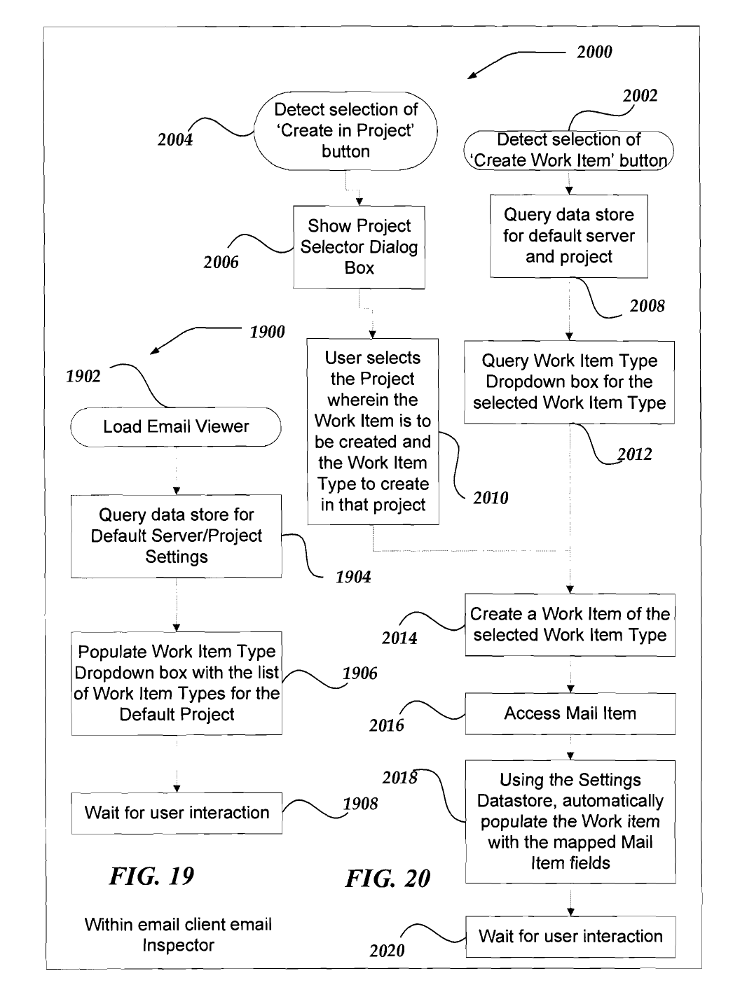

FIG. 19 is a flow diagram 1900 illustrating example logical operations for determining available work item types. The work item form window, the options settings dialog boxes, email messages, and/or other user interfaces may enable the user to selectively assign work item types. The types of work items may be specified in the local settings file or other data store. For example, upon loading an email viewer module at operation 1902 to display an email message, loading the email client, displaying the work item form window, or opening an email message, the work item management module may query the settings file for default server and/or projects settings at operation 1904. The available work item types for a default or selected server and project may then be made available at operation 1906 for drop down boxes or other user interface elements that enable the user to select a work item type. Again, at operation 1908, the work item management module waits for further user interaction with the dialog box.

FIG. 20 is a flow diagram 2000 illustrating example logical operations for creating a work item from an email message. As discussed above, the work item may be created by selecting a “create work item” button or selecting a “create in project” button. If the “create in project” button is selected at operation 2004, the work item management module displays a project selector dialog box at operation 2006 and detects a user's selection at operation 2010 of a project with which the newly created work item is to be associated. A selected work item type is also detected through the dialog box. Alternatively, if the “create work item” button is selected at operation 2002, the work item management module checks the settings file at operation 2008 for the default server and project. A work item type may be determined from a user's selection in a drop down box (or a default setting) at operation 2012.

Once the work item type is defined, the work item management module creates a work item object at operation 2014. The work item management module may use an API, such as Microsoft Corporation's Team System API, to create the work item. The work item may comprise a temporary local instantiation until it is submitted to the development environment server. Alternatively, the work item management module may access the development environment server to instantiate the new work item and/or obtain basic work item information. In either case, at operation 2016, the work item management module accesses data fields of the email message, and maps the email data to data fields of the work item. As discussed above, the work item management module accesses the settings file for the mapping of data fields between the email message and the work item at operation 2018. Once the data is mapped to the work item, the work item management module awaits further user input at operation 2020. If the user selects to save the new work item, the work item management module communicates the new work item to the development environment server. The new work item may then be accessed by other clients.

The above specification, examples, and data provide a complete description of the manufacture and use of the composition of the invention. Additional information in provided in the attached appendix which forms an integral part of this specification and is specifically incorporated into the specification of this application. Since many embodiments of the invention can be made without departing from the spirit and scope of the invention, the invention resides in the claims hereinafter appended.

What is claimed as new and desired to be protected by Letters Patent is:

1. A method for managing work item data, comprising:
enabling the work item data to be manipulated through a user interface of a client application arranged to execute independent of a work management application that is arranged to use the work item data for managing work; and
enabling the work management application to determine a setting of the work item data manipulated through the user interface of the client application.

2. The method of claim 1, wherein:
the work management application comprise a software development application; and
the client application comprises one of the following: a messaging application, a calendaring application, a word processing application, and a spreadsheet application.

3. The method of claim 1, wherein enabling the work item data to be manipulated comprises enabling the work item data to be at least one of the following: created, retrieved, modified, and deleted.

4. The method of claim 1, wherein enabling the work management application to determine a setting comprises enabling the work management application to determine at least one of the following:
that the work item data was created;
that the work item data was modified;
that the work item data was deleted; and

5. The method of claim 1, wherein the setting comprises at least one of the following:
a mapping of the work item data between fields of the work management application and the client application;
a work item type; and
a default value.

6. The method of claim 1, wherein the work item data is stored in one of the following: a client data store and a network server data store.

7. The method of claim 1, wherein the client application one of the followin:
interfaces with a work item management module that enables the work item data to be manipulated through the user interface of the client application; and
includes a work item management module that enables the work item data to be manipulated through the user interface of the client application.

8. The method of claim 1, wherein the user interface of the client application includes a toolbar that enables the work item data to be manipulated.
The method of claim 1, wherein the work item data is associated with at least one of the following: a server and a project.

9. The method of claim 1, further comprising at least one of:
obtaining the work item data from a data field of a user message received by the client application;
populating a data field of a work item form with the work item data received by the client application in a user message; and
displaying the work item data in a message produced at least in part by the client application.

10. A computer readable storage medium storing computer executable instructions that enable a computer to perform the operations of claim 1.

11. An apparatus for managing work item data, comprising:
a processor;
a user interface in communication with the processor;
a memory in communication with the processor and storing instructions that cause the processor to perform a plurality of operations, including:
enabling the work item data to be manipulated through a user interface of a client application arranged to execute independent of a work management application arranged to use the work item data for managing work; and
enabling the work management application to determine a setting of the work item data manipulated through the user interface of the client application.

12. The apparatus of claim 11, wherein:
the work management application comprise a software development application; and
the client application comprises one of the following: a messaging application, a calendaring application, a word processing application, and a spreadsheet application.

13. The apparatus of claim 11, wherein the instructions that cause the processor to perform the operation of enabling the work item data to be manipulated, further cause the processor to perform the operation of comprises enabling the work item data to be at least one of the following: created, retrieved, modified, and deleted.

14. The apparatus of claim 11, wherein the setting comprises at least one of the following:
a mapping of the work item data between fields of the work management application and the client application;
a work item type; and
a default value.

15. The apparatus of claim 11, wherein the user interface of the client application includes a toolbar that enables the work item data to be manipulated.

16. The apparatus of claim 11, wherein the instructions further cause the processor to perform at least one of the following operations of:
obtaining the work item data from a data field of a user message received by the client application;
populating a data field of a work item form with the work item data received by the client application in a user message;and
displaying the work item data in a message produced at least in part by the client application.

17. A system for managing work item data, comprising:
a client application arranged to execute independent of a work management application that is arranged to use the work item data for managing work; and
a work item management module that:
enables the work item data to be manipulated through a user interface of the client application; and
enables the work management application to determine a setting of the work item data manipulated through the user interface of the client application.

18. The system of claim 19, wherein:
the work management application comprise a software development application; and
the client application comprises one of the following: a messaging application, a calendaring application, a word processing application, and a spreadsheet application.

19. The system of claim 19, wherein the client application one of the following:
interfaces with the work item management module that enables the work item data to be manipulated through the user interface of the client application; and
includes the work item management module that enables the work item data to be manipulated through the user interface of the client application.

20. The system of claim 19,further comprising a settings data store, storing the setting, which comprises at least one of;
a mapping of the work item data between fields of the work management application and the client application;
a work item type; and
a default value.

21. A method for managing work item data, comprising:
providing a work item user interface in a client application for manipulating the work item data; wherein the client application is not natively capable of manipulating the work item data;
detecting a user request through the client application to manipulate the work item data with the work item use interface; and
displaying the work item data through the work item user interface with the client application.

22. The method of claim 21, wherein the client application comprises one of the following, a messaging application, a word processing application, and a spreadsheet application.

23. The method of claim 21, wherein the request comprises a query for a subset of work item data.
